(19) United States
(12) Patent Application Publication
(10) Pub. No.: US 2011/0013577 A1
(43) Pub. Date: Jan. 20, 2011

(54) METHOD AND NETWORK DEVICE FOR CONTROLLING USER EQUIPMENT ACCESS IN MULTI-FREQUENCY SYSTEM

(75) Inventors: Zongjie WANG, Shenzhen (CN); Chuanfeng He, Shenzhen (CN); Zhiqin Yu, Shenzhen (CN); Jie Ma, Shenzhen (CN); Yi Zhang, Shenzhen (CN); Jinlin Zhang, Shenzhen (CN)

Correspondence Address: STAAS & HALSEY LLP, SUITE 700, 1201 NEW YORK AVENUE, N.W., WASHINGTON, DC, 20005, US

(73) Assignee: Huawei Technologies Co., Ltd., Shenzhen (CN)

(21) Appl. No.: 12/889,587

(22) Filed: Sep. 24, 2010

Related U.S. Application Data
(63) Continuation of application No. PCT/CN2009/070722, filed on Mar. 10, 2009.

(30) Foreign Application Priority Data
Mar. 25, 2008 (CN) 200810066184.6
Apr. 23, 2008 (CN) 200810095729.6

(51) Int. Cl. H04W 72/04

(52) U.S. Cl. 370/329; 455/450

(57) ABSTRACT

A method for controlling user equipment (UE) access in a multi-frequency system in the field of communication is provided. The method includes the following steps. A network side receives an access preamble sent by a UE on one frequency. When the network side determines that the UE needs to access on another frequency, the network side notifies the UE to access by switching to another frequency. Network device is also provided at the same time. Therefore, the UE access can be controlled according to a practical situation of the UE or each frequency, and the flexibility of the multi-frequency system is enhanced.

### CROSS-REFERENCE TO RELATED APPLICATIONS

This application is a continuation of International Application No. PCT/CN2009/070722, filed on Mar. 10, 2009, which claims priority to Chinese Patent Application No. 200810066184.6, filed on Mar. 25, 2008, and China Patent Application No. 200810095729.6, filed on Apr. 23, 2008, all of which are hereby incorporated by reference in their entireties.

### FIELD OF THE INVENTION

The present invention relates to the field of mobile communications, and more particularly, to a method and network device for controlling user equipment (UE) access in a multi-frequency system.

### BACKGROUND OF THE INVENTION

A High Speed Packet Access (HSPA) technology is a new technology introduced after Release 5 (R5) version of the 3rd Generation Partnership Project (3GPP). The HSPA technology is applicable to three different transmission modes, namely, the Wide Code Division Multiple Access Frequency Division Duplex (WCDMA FDD), the Terrestrial Radio Access Frequency Division Duplex (UTRA TDD), and the Time Division-Synchronous Code Division Multiple Access (TD-SCDMA). Generally, HSPA transmits data on a single frequency. To further enhance a data transmission rate of the HSPA system and reduce a transmission time delay of data, a system binding multiple frequencies to transmit HSPA data emerges, that is, a multi-frequency HSPA system emerges. In a multi-frequency HSPA system, data channels of multiple frequencies in the downlink direction are bound together to transmit HSPA data. That is, user equipment (UE) receives data of data channels on multiple carriers simultaneously. Specifically, the UE estimates a channel according to a pilot in a Common Pilot Channel (CPICH), so as to obtain a transmission function of the channel, and the data on the multiple data channels is obtained through inverse transformation.

In the prior art, in a multi-frequency cell, only data channels for data transmission are configured on each frequency. All downlink common channels are configured on one frequency or only part of the downlink common channels are configured on each frequency conditionally (as described above, to bind data on multiple frequencies, the CPICH is configured on each frequency). Therefore, after the UE is switched on, synchronization and access can be performed only on the frequency configured with the downlink common channels.

For example, when the UE performs random access, an access preamble is sent with a certain transmission power on a random access channel (RACH) on the frequency configured with the downlink common channel. After the network side receives the access preamble, if a corresponding access resource exists, the network side returns an Acknowledge (ACK) as a feedback on an Acquisition Indicator Channel (AICH), and after the UE receives the ACK, the UE sends an access message on the RACH and completes the access. If no corresponding access resource exists, the network side returns a Negative Acknowledgement (NACK) on the AICH. After the UE receives the NACK, the UE reinitiates an access procedure after a period of time. If the UE still does not receive the ACK after a period of time, the UE sends an access preamble with a larger transmission power. If the UE does not receive any ACK on the AICH, the above procedure is repeated, and the UE quits the access after the procedure is performed up to a maximum of retransmission times.

The inventors of the present invention found that in the prior art all downlink common channels of a multi-frequency system are configured on one frequency (or only part of the downlink common channels are configured on other frequencies conditionally), so that the UE only performs an access procedure on the frequency configured with the downlink common channels, which may result in overload on the frequency and impact on the advantages of the multi-frequency system.

### SUMMARY OF THE INVENTION

Accordingly, the embodiments of the present invention are directed to a method and network device for controlling user equipment (UE) access in a multi-frequency system, so as to increase a success ratio of the UE access and exert the advantages of the multi-frequency system.

An aspect of the present invention provides a method for controlling UE access in a multi-frequency system. The method includes the following steps: A network side receives an access preamble sent by a UE on a frequency, where the access preamble is enable the UE to initiate an access on the current frequency. When the network side determines that the UE needs to access the network on another frequency, the network side notifies the UE to access on another frequency.

Another aspect of the present invention further provides a network device. The network device includes a receiving unit, a determining unit, and a sending unit.

The receiving unit is adapted to receive an access preamble sent by a UE on a frequency. The determining unit is adapted to determine whether the UE needs to access on another frequency. The sending unit is adapted to notify the UE to access on another frequency when the determining unit determines that the UE needs to access on another frequency.

Compared with the prior art, according to the method and network device of the present invention, the network side notifies the UE to access on another frequency when the network side determines that the UE needs to access on another frequency. Therefore, the ratio for the UE to access the network successfully may be increased and the advantages of the multi-frequency system may be exerted.

### BRIEF DESCRIPTION OF THE DRAWINGS

FIG. 1 is a schematic flow chart of a method for controlling UE access in a multi-frequency system according to an embodiment of the present invention; and

FIG. 2 is a schematic structural view of network device according to an embodiment of the present invention.

### DETAILED DESCRIPTION OF THE EMBODIMENTS

In an embodiment of the present invention, a method for controlling user equipment (UE) access in a multi-frequency system is provided. In the method, a network side receives an access preamble sent by a UE on a frequency. When the network side determines that the UE needs to access on another frequency, the network side notifies the UE to access on another frequency. By using this method, the network side can control UE access according to practical situations of the UE or practical situations of each frequency. Therefore, the ratio for the UE to access the network successfully may be increased and the multi-frequency system may be more flexible.

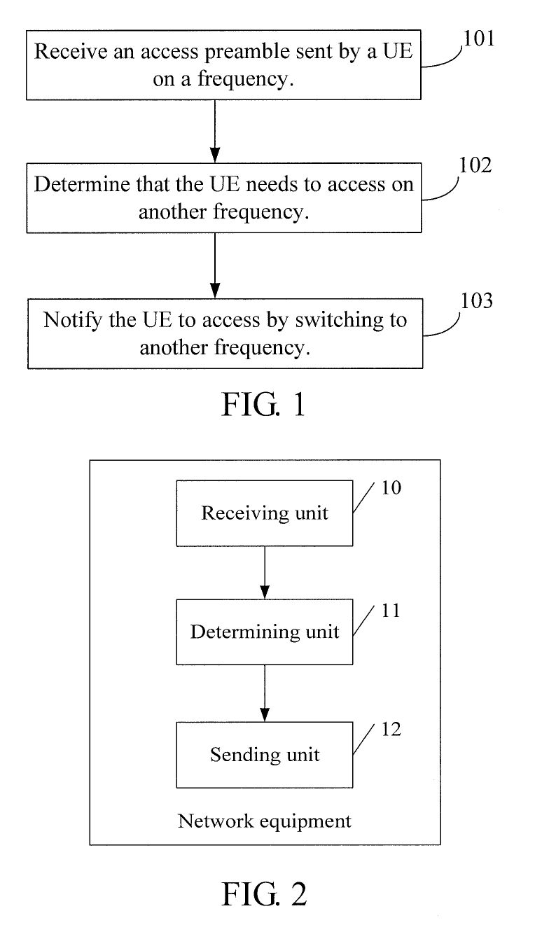

Referring to FIG. 1, a schematic flow chart according to an embodiment of the present invention is described in the following.

In step 101, a network side receives an access preamble sent by a UE on a frequency.

The access preamble is used to request to access a current frequency by the UE. If the network side only configures downlink common channels on one frequency, the UE can access on this frequency only.

According to one embodiment of the present invention, downlink common channels may be configured on all frequencies of the multi-frequency system, which can make the UE access the network on anyone of the frequencies configured downlink common channels.

In order to enable the UE to access on any of frequencies, a Primary Common Control Physical Channel (P-CCPCH) and a Primary Common Pilot Channel (P-CPICH) are configured to be sent on each frequency. Therefore, the UE can access on anyone of frequencies.

Alternatively, a Primary Synchronization Channel (P-SCH) and a Secondary Synchronization Channel (S-SCH) may be configured to be sent on each frequency, so that the UE can perform cell synchronization on anyone of frequencies.

Of course, the P-SCH and the S-SCH may be configured to be sent on one frequency only. In such case, the UE can perform the cell synchronization only on the frequency configured with the P-SCH and the S-SCH. Alternatively, an indicator (or an information element) may be added in a broadcast message on the frequency configured with the P-SCH and the S-SCH, so as to indicate that part of UEs select other frequencies to reside. Therefore, once the UE is switched on and start to synchronize, the UE may receive the broadcast message through the P-CCPCH to determine whether the UE selects another frequency to reside. For example, the network side may instruct part of UEs to select other frequencies to reside according to factors such as a load condition, UE capability, or UE service requirement of each frequency.

Alternatively, the P-CCPCH of each frequency can be configured to carry at least one configuration parameter of a downlink common channel of another frequency. For example, a configuration parameter of a paging channel (PCH) of another frequency may be added in a broadcast message of the P-CCPCH. Therefore, when the UE performs a cell selection after the UE is switched on, the UE may obtain configuration parameters of downlink common channels of other frequencies through a broadcast message of one frequency, so as to save the time that the UE reads broadcast information on other frequencies, and reduce the time that the UE selects an appropriate cell to reside.

Furthermore, paging occasions of UEs on different frequencies may be configured to have an interval (that is, a time interval exists among the paging of different frequencies). Meanwhile, a longer paging period of each frequency may be configured so as to reduce the paging load on each frequency.

Further, it can be configured that downlink frame boundaries of different frequencies are aligned with each other, so as to ensure coordination and synchronization of different frequencies. Therefore, the design of the system is simplified. In the multi-frequency system, the alignment of the downlink frame boundaries may be ensured through the clocks of each frequency.

Alternatively, an indicator (or an information element) may be added in a broadcast message, so as to indicate to the UE whether the multi-frequency channel configuration is supported in the current cell. By using the channel configuration scheme, the characteristics and advantages of the multi-frequency system are fully exerted, and the multi-frequency system becomes more flexible.

In step 102, the network side determines that the UE needs to access on another frequency.

In this step, the network side coordinates the UE's access according to factors such as a load condition on each frequency, UE capability, or UE service requirement, so as to balance the load on each frequency. For example, maximum times that the UE sends the access preamble may be set in advance on the network side, and when the times of the UE sending the access preamble exceeds the maximum times as set on the network side, it is determined that the UE needs to attempt to access by switching to another frequency. Alternatively, it is determined that the UE needs to attempt to access on another frequency according to the times of NACK which the network side sends.

In step 103, the network side notifies the UE to access by switching to another frequency.

The network side notifies the UE to access by switching to another frequency at least by using in the following methods.

(1) An indicator (or an information element) may be added in the broadcast message, so as to notify the UE to attempt to access by switching to another frequency.

(2) The network side sends an Extended-Acquisition Indicator (E-AI) indicating the resource available to the UE, so as to instruct the UE to attempt to access by switching to another frequency.

The E-AI is one of 31 E-AIs, where the 31 E-AIs indicate numbers of resources available to the UE and the 31 E-AIs are sent through the AICH of the Node B. Taking an HSPA system as an example, in the HSPA system, 32 E-AIs are sent on an AICH. The 32 E-AIs are formed of combinations of different values (that is, +1 or −1) of 16 signature sequences. Among the 32 E-AIs, 31 E-AIs indicate numbers of resources available to the UE, and the rest one indicates the NACK. Therefore, one E-AI is selected from the 31 E-AIs (as a specific E-AI) to indicate that the network side requires the UE to attempt to access by switching to another frequency.

Further, in the E-AI and corresponding indication information thereof broadcasted by the network side, the indication information corresponding to the specific E-AI may be modified into “Retry other carriers”. The indication information may also be modified into specific indication of which carrier to access, such as “Retry carrier 1” and “Retry carrier 2”. One example of a modified E-AI and the indication information that corresponds to the modified E-AI are shown in the following table.

| | | E-DCH resource |
|---|---|---|
| NodeB Transmitted | NodeB Transmitted | configuration |
| E-AI on E-AICH | Signature on E-AICH | index |
| +1 | 0 | NACK |
| −1 | | Retry other carriers |
| +1 | 1 | (X + 1)mod Y |
| −1 | | (X + 2)mod Y |
| +1 | 2 | (X + 3)mod Y |
| −1 | | (X + 4)mod Y |
| +1 | 3 | (X + 5)mod Y |
| −1 | | (X + 6)mod Y |
| +1 | 4 | (X + 7)mod Y |
| −1 | | (X + 8)mod Y |
| +1 | 5 | (X + 9)mod Y |
| −1 | | (X + 10)mod Y |
| +1 | 6 | (X + 11)mod Y |
| −1 | | (X + 12)mod Y |
| +1 | 7 | (X + 13)mod Y |
| −1 | | (X + 14)mod Y |
| +1 | 8 | (X + 15)mod Y |
| −1 | | (X + 16)mod Y |
| +1 | 9 | (X + 17)mod Y |
| −1 | | (X + 18)mod Y |
| +1 | 10 | (X + 19)mod Y |
| −1 | | (X + 20)mod Y |
| +1 | 11 | (X + 21)mod Y |
| −1 | | (X + 22)mod Y |
| +1 | 12 | (X + 23)mod Y |
| −1 | | (X + 24)mod Y |
| +1 | 13 | (X + 25)mod Y |
| −1 | | (X + 26)mod Y |
| +1 | 14 | (X + 27)mod Y |
| −1 | | (X + 28)mod Y |
| +1 | 15 | (X + 29)mod Y |
| −1 | | (X + 30)mod Y |

When the network side determines that the UE needs to attempt to access by switching to another frequency, the network side may send the specific E-AI to the UE through the AICH. After receiving the specific E-AI, the UE receives downlink information on another frequency according to the indication information corresponding to the specific E-AI (for example, the indication information is “Retry other carriers”), sends the access preamble to the network side, and attempts to access on another frequency.

It should be noted that, the network side may also notify, through a broadcast message, the UE to proactively attempt to access by switching to another frequency after the NACK sent by the network side is received on the frequency currently requesting for access more than maximum times predetermined by the network side.

By using the method according to this embodiment, the network side may better manage the access procedure of the UE and fully exert the advantages of the multi-frequency system. Moreover, the switching of the access carriers enables control of the random access of the UE according to the load of the carriers, so as to improve the control of a cell uplink interference level and reduce the congestion probability.

Through the above description of the embodiments, it is apparent to those skilled in the art that the present invention may be accomplished by software on a necessary hardware platform, and of course may also be accomplished by hardware. Therefore, the technical solutions of the present invention or the part that makes contribution to the prior art can be substantially embodied in the form of a software product. The computer software product is stored in a storage medium and contains several instructions to instruct the equipment to perform the methods as described in the embodiments of the present invention.

In an embodiment, the present invention further provides equipment for controlling UE access in a multi-frequency system, which includes a receiving unit 10, a determining unit 11, and a sending unit 12.

The receiving unit 10 is adapted to receive an access preamble sent by a UE on a frequency.

The determining unit 11 is adapted to determine whether the UE needs to access on another frequency.

The sending unit 12 is adapted to notify the UE to access on another frequency when the determining unit 11 determines that the UE needs to access on the other frequency.

When the network side receives the access preamble sent by the UE more than predetermined maximum times or the network side sends the NACK to the UE more than predetermined maximum times, the determining unit 11 determines that the UE needs to access on another frequency.

The sending unit 12 instructs the UE to access on another frequency by sending a specific E-AI to the UE or by a parameter in a broadcast channel.

With the equipment provided in this embodiment, the UE access procedure may be better managed, so as to fully exert the advantages of the multi-frequency system.

The equipment may further include a channel configuration unit 13.

The channel configuration unit 13 is adapted to configure a downlink common channel for each frequency in the multi-frequency system.

The channel configuration unit 13 configures that at least a P-CCPCH and a P-CPICH are sent on each frequency. Therefore, the UE can select a random frequency in the multi-frequency system for access.

Alternatively, the channel configuration unit 13 is further adapted to configure that a P-SCH and an S-SCH are sent on each frequency. Therefore, the UE can perform cell synchronization on a random frequency.

Of course, the channel configuration unit 13 can also configure that the P-SCH and the S-SCH are sent on only one frequency. At this time, the UE can perform the cell synchronization only on the frequency configured with the P-SCH and the S-SCH.

Alternatively, the channel configuration unit 13 may add an indicator (or referred to as an information element) in a broadcast message on the frequency configured with the P-SCH and the S-SCH, so as to instruct part of the UEs to select other frequencies to reside. Therefore, after the UE is started and synchronized, the UE receives the broadcast message through the P-CCPCH to determine whether the UE selects another frequency to reside. For example, the network side may instruct part of UEs to select other frequencies to reside according to factors such as a load condition, UE capability, and UE service requirement of each frequency.

Alternatively, the channel configuration unit 13 may be adapted to configure that the P-CCPCH of each frequency bears at least one configuration parameter of a downlink common channels of another frequency. Therefore, after the UE is started and performs cell selection, the UE may obtain the configuration parameter of the downlink common channel of the other frequency through a broadcast message of one frequency, so as to save the time that the UE reads broadcast information on other frequencies, and short the time that the UE selects an appropriate cell to reside.

More specifically, the channel configuration unit 13 may configure that paging occasions of UEs on different frequencies are spaced from each other (that is, a time difference exists between the paging of different frequencies) and configure a paging period of each frequency longer, so as to reduce the paging load on each frequency.

Moreover, the channel configuration unit 13 may configure that downlink frame boundaries of different frequencies are aligned with each other, so as to ensure coordination and synchronization of different frequencies, thus simplifying the design of the system. In the multi-frequency system, the alignment of the downlink frame boundaries may be ensured through the clocks of different frequencies.

Alternatively, the channel configuration unit 13 may add an indicator (or referred to as an information element) in a broadcast message, so as to indicate the UE whether the multi-frequency channel configuration is supported in the current cell. By using the channel configuration scheme, the characteristics and advantages of the multi-frequency system are fully exerted, and the multi-frequency system becomes more flexible.

Through the device according to this embodiment, the network side may better manage the access procedure of the UE and fully exert the advantages of the multi-frequency system. Moreover, the switching of the access carriers enables control of the random access of the UE according to the load of the carriers, so as to improve the control of a cell uplink interference level and reduce the congestion probability.

Any modification, equivalent replacement, or improvement made without departing from the spirit and principle of the present invention should fall within the scope of the present invention.

What is claimed is:

1. A method for controlling user equipment (UE) access in a multi-frequency system, comprising:
receiving, by a network side, an access preamble sent by a UE on a frequency, wherein the access preamble is used to access on the frequency by the UE;
notifying, by the network side, the UE to access on another frequency when the network side determines that the UE needs to access on the other frequency.

2. The method according to claim 1, wherein the notifying, by the network side, the UE to access on the other frequency comprises:
sending, by the network side, an Extended-Acquisition Indicator (E-AI) through an Acquisition Indicator Channel (AICH) to instruct the UE to access on the other frequency.

3. The method according to claim 1, further comprising: configuring a downlink common channel for each frequency in the multi-frequency system.

4. The method according to claim 3, further comprising:
configuring that downlink frame boundaries of different frequencies in the multi-frequency system are aligned with each other.

5. The method according to claim 3, wherein the configuring the downlink common channel for each frequency in the multi-frequency system comprises:
configuring a Primary Common Control Physical Channel (P-CCPCH) and a Primary Common Pilot Channel (P-CPICH) on each frequency.

6. The method according to claim 5, further comprising:
configuring a Primary Synchronization Channel (P-SCH) and a Secondary Synchronization Channel (S-SCH) on one frequency only; and
adding an indicator in a broadcast message on the frequency configured with the P-SCH and the S-SCH to indicate whether the UE selects another frequency to access.

7. A network device, comprising:
a receiving unit, adapted to receive an access preamble sent by a user equipment (UE) on a frequency;
a determining unit, adapted to determine whether the UE needs to access on another frequency;
a sending unit, adapted to notify the UE to access on the other frequency when the determining unit determines that the UE needs to access on the other frequency.

8. The network device according to claim 8, further comprising:
a channel configuration unit, adapted to configure a downlink common channel for each frequency in a multi-frequency system.

9. The network device according to claim 8, wherein the channel configuration unit is further adapted to configure that a Primary Common Control Physical Channel (P-CCPCH) of each frequency bears at least one configuration parameter of the downlink common channel of another frequency.

10. The network device according to claim 8, wherein the channel configuration unit is further adapted to configure that downlink frame boundaries of the frequencies are aligned with each other.

11. A method for configuring downlink common channel in multi-carries system, comprising:
configuring a downlink common channel in a multi-carriers system; and
configuring downlink frame boundaries of frequencies of the multi-carries system aligning with each other.

12. The method according to claim 11, wherein configuring a downlink common channel in a multi-carriers system comprises:
configuring a Primary Common Control Physical Channel (P-CCPCH) and a Primary Common Pilot Channel (P-CPICH) on each frequency.

13. The method according to claim 12, further comprising:
configuring that the P-CCPCH of each frequency carries at least one configuration parameter of the downlink common channel of another frequency.

14. The method according to claim 11, wherein configuring a downlink common channel in a multi-carriers system further comprises:
configuring a Primary Synchronization Channel (P-SCH) and a Secondary Synchronization Channel (S-SCH) on each frequency; and
configuring the P-SCH of each frequency aligning with each other.

15. The method according to claim 11, wherein configuring the downlink common channel in the multi-carriers system further comprises:
configuring a P-SCH and a S-SCH on one frequency only; and
adding an indicator in a broadcast message on the frequency configured with the P-SCH and the S-SCH to indicate whether the UE selects another frequency to access.

16. A network device for configuring downlink common channel in multi-carries system, comprising:
a first unit, configured to configure a downlink common channel in a multi-carriers system; and
a second unit, configured to configure downlink frame boundaries of frequencies of the multi-carries system aligning with each other.

17. The network device according to claim 16, wherein further comprising:
a third unit, configured to configure a Primary Common Control Physical Channel (P-CCPCH) and a Primary Common Pilot Channel (P-CPICH) on each frequency.

18. The network device according to claim 17, further comprising:
a fourth unit, configured to configure that the P-CCPCH of each frequency carries at least one configuration parameter of the downlink common channel of another frequency.

19. The network device according to claim 16, wherein further comprising:
a fifth unit, configured to configure a Primary Synchronization Channel (P-SCH) and a Secondary Synchronization Channel (S-SCH) on each frequency; and
a sixth unit, configured to configure the P-SCH of each frequency aligning with each other.

20. The network device according to claim 16, wherein further comprising:
a seventh unit, configured to configure a P-SCH and a S-SCH on one frequency only; and
a eighth unit, configured to add an indicator in a broadcast message on the frequency configured with the P-SCH and the S-SCH to indicate whether the UE selects another frequency to access.
